(19) United States
(12) Patent Application Publication
(10) Pub. No.: US 2006/0155912 A1
(43) Pub. Date: Jul. 13, 2006

(54) Server cluster having a virtual server

(75) Inventors: Sumankumar A. Singh, Pflugerville, TX (US); Timothy E. Abels, Pflugerville, TX (US); Peyman Najafirad, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/034,384

(22) Filed: Jan. 12, 2005

(51) Int. Cl. G06F 21/00

(52) U.S. Cl. 711/6

(57) ABSTRACT

An architecture and method of operation of a server cluster is disclosed in which a virtual standby node is established for each active node of the server cluster. The virtual nodes are each housed in singly physical server. The standby cluster also includes a monitoring module for monitoring the operational status of each virtual machine of the standby node. A cloning and seeding agent is included in the standby node for creating copies of virtual machines and managing the promotion of virtual machines to an operational state.

### TECHNICAL FIELD

The present disclosure relates generally to computer networks, and, more specifically a server cluster that includes one or more virtual servers in a standby mode.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

Computer systems, including servers and workstations, are often grouped in clusters to perform specific tasks. A server cluster is a group of independent servers that is managed as a single system and is characterized by high availability, manageability, and scalability, as compared with groupings of unmanaged servers. At a minimum, a server cluster includes two servers, which are sometimes referred to as nodes.

In server clusters designed for high availability applications, each node of the server cluster is associated with a standby node. When the primary node fails, the application or applications of the node are restarted on the standby node. Although this architecture provides for failure protection and high availability for the primary node, the standby node is idle the far majority of the time, and the available capacity of the standby node is unused. The misuse of capacity of standby nodes is often exacerbated by the software architecture of the primary node. Some software applications cannot exist in multiple instances on a single primary node. Each instance of the software application must exist on a separate primary node, thereby requiring that a standby node be in place for each primary node. As another example, some primary nodes are able to run only a single operating system. When multiple instances of a software application must be run on different operating systems, a separate primary node must be established for each different operating system, and a separate standby node must be established for each primary node.

### SUMMARY

In accordance with the present disclosure, an architecture and method of operation of a server cluster is disclosed in which a virtual standby node is established for each active node of the server cluster. The virtual nodes are each housed in singly physical server. The standby cluster also includes a monitoring module for monitoring the operational status of each virtual machine of the standby node. A cloning and seeding agent is included in the standby node for creating copies of virtual machines and managing the promotion of virtual machines to an operational state.

The server cluster architecture and method described herein is advantageous in that it provides for the efficient user of server resources in the server cluster. In the architecture of the present invention, a single standby node is established for housing virtual failover nodes associated with each of the physical servers of the server cluster. This architecture eliminates the necessity of establishing a separate and often underutilized physical standby node for each active node of the server cluster. If a primary node fails, the operating system and applications of the failed node can be restarted on the associated virtual node.

Another technical advantage of the architecture and method described herein is the provision of a method for monitoring the physical applications of the active node of the cluster and the virtual nodes of a standby node of the cluster. Because the utilization of each of the applications of the primary node and the virtual nodes is monitored, a more efficient and robust use of network resources is disclosed. If an application of a primary node reaches a utilization threshold, some or all of the workload of the application can be transferred to the corresponding virtual node. Similarly, if the workload of a virtual node exceeds a utilization threshold, the application of the virtual node can be transferred to a physical node.

The architecture and method disclosed herein also provides a technique for managing the creation and existence of a hot spare virtual machine and a warm spare virtual machine. Each virtual node includes a hot spare virtual machine and an associated warm spare virtual machine. The warm spare virtual machine remains unlicensed until such time as the warm spare will be used and a licensed will be required. Thus, license resources are not expended as to the warm spare virtual machine until a license is required at a time when the warm spare virtual machine will be elevated to the status of a hot spare virtual machine.

The architecture disclosed herein is additionally advantageous in that it provides for the rapid scale-out or scale-in of virtual applications in response to the demands being placed on a physical application of the network. As the demands on a physical application increases, one or more virtual applications could be initiated to share the workload of the physical application. As the workload of the physical application subsides, one or more virtual applications could be terminated. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a cluster server;

FIG. 2 is a diagram of a standby node;

FIG. 3 is a flow diagram of a method for managing the operation and configuration of the hot spare virtual machines and warm spare virtual machines of the virtual nodes of a standby node;

FIG. 4 is a flow diagram of a series of method steps for managing the operation of a primary node on the basis of threshold utilization levels set with reference to the operation of the primary node;

FIG. 5 is a flow diagram of a series of method steps for managing the operation of a primary node on the basis of threshold utilization levels set with reference to the operation of the hot spare virtual machine;

FIG. 6 is a flow diagram of a series of method steps for managing the operation of a primary node on the basis of redundancy threshold utilization levels set with reference to the operation of the application of the primary node;

FIG. 7 is a flow diagram of a series of method steps for managing the operation of a primary node on the basis of redundancy threshold utilization levels set with reference to the operation of the hot spare virtual machine of the primary node;

FIG. 8 is a flow diagram of a series of method steps for managing the operation of a warm spare virtual machine within a standby node;

FIG. 9 is a series of method steps for monitoring the operation of virtual machines within a standby node;

FIG. 10 is a diagram of a primary node that has been scaled through the use of multiple virtual nodes in multiple physical nodes; and

FIG. 11 is a diagram of a primary node that has been scaled through the use of multiple virtual nodes in a single physical node.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

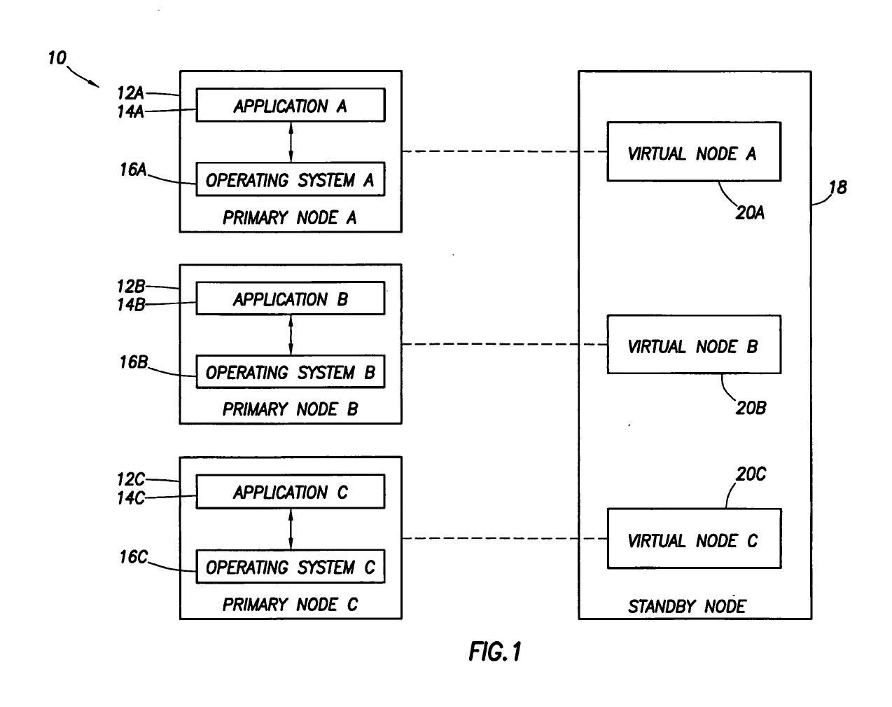

Shown in FIG. 1 is a diagram of a server cluster, which is indicated generally at 10. Server cluster 10 includes three primary nodes 12, which are identified as Primary Node A (12A), Primary Node B (12B), and Primary Node C (12C). Server cluster 10 also includes a standby node 18. Each primary node includes an operating system, which is identified at 16A with respect to Primary Node A, 16B with respect to Primary Node B, and 16C with respect to Primary Node C. Each primary node also includes at least one application, which is identified at 14A in Primary Node A, 14B in Primary Node B, and 14C in Primary Node C. Each primary node 12 is associated with a virtual node 20. Primary Node A is associated with Virtual Node A (20A); Primary Node B is associated with Virtual Node B (20B); and Primary Node C is associated with Virtual Node C (20C). The virtual nodes each run within standby node 18. In the event of a failure of a primary node, the operating system and applications of the failed primary node can be restarted on the virtual node. Each virtual node includes, at a minimum, a hot spare virtual machine of the primary node. The hot spare virtual machine is a replicated version of the operating system and applications of the primary node. The hot spare virtual machine includes a virtual representation of the hardware and software environment of the primary node, enabling the operating system and applications of the primary node to be quickly restarted or failed over to the hot spare of the primary node.

As indicated in FIG. 1, each standby node will include multiple virtual servers. Each virtual server may run a different operating system. The use of the server cluster architecture of FIG. 1 dispenses with the need to associate a single physical standby node with each physical primary node. In the architecture of FIG. 1, a single physical standby node supports three physical primary nodes, and the capacity of the single physical standby node is efficiently utilized with the virtual nodes running in the standby node.

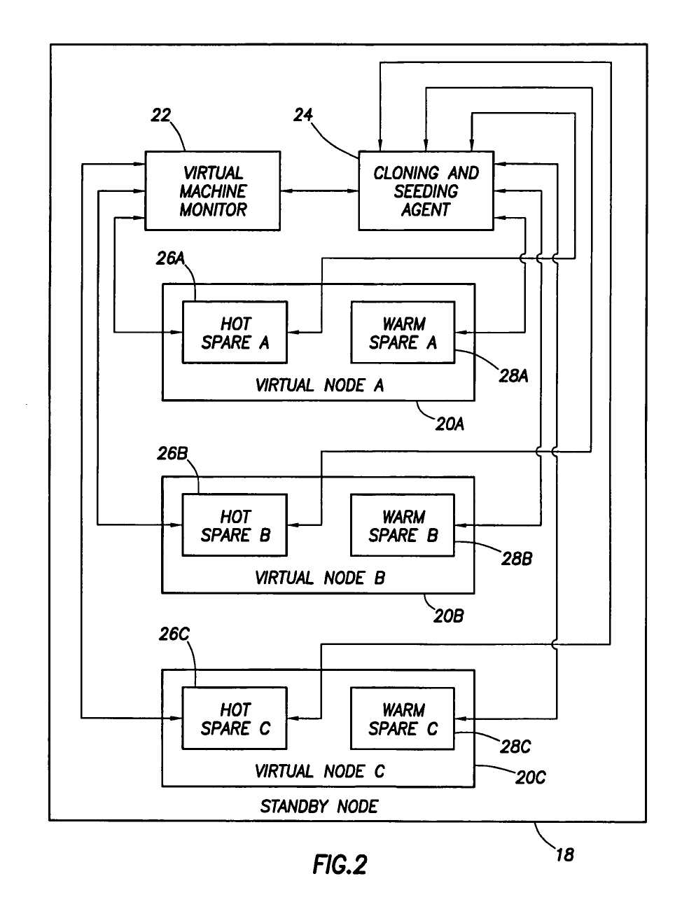

Shown in FIG. 2 is a detailed diagram of standby node 18. In the example of FIG. 2, standby node 18 includes three virtual nodes 20. Each virtual node includes a hot spare virtual machine 26 and a warm spare virtual machine 28. As described, the hot spare virtual machine is a replicated virtual representation of the hardware and software environment of the associated primary node. In the example of FIGS. 1 and 2, hot spare virtual machine 26A is a virtual representation of the hardware and software environment of primary node 12A. Hot spare virtual machine 26 is able to handle some or all of the operating function of the associated primary node. In the event of a failure of the primary node, the operating system and applications of the primary node can be restarted on the hot spare virtual machine. If the primary node has exceeded a capacity threshold, some portion of the operating functions of the primary node can be transferred to the associated host spare virtual machine.

Each virtual node 20 also includes a warm spare virtual machine 28. Like hot spare virtual machine 26, warm spare virtual machine 28 includes a virtual representation of the hardware and software environment of the associated primary node. One difference between warm spare virtual machine 28 and hot spare virtual machine 26 is that warm spare virtual machine 28 is not licensed for use. Before warm spare virtual machine 28 can be activated and elevated to the status of a hot spare virtual machine 26, warm spare virtual machine 28 must be licensed. Warm spare virtual machine 28 will become licensed at a time when a license is required for operation. The licensing of warm spare virtual machine 28 can occur instantaneously, as the licensing of software applications on an enterprise basis can, depending on the particular licensing arrangements, be accomplished by maintaining records of the number of applications used during a period or in use at any point during a period. As such, warm spare virtual machine 28 can be configured for use as a hot spare by changing the license status of the warm spare virtual machine.

Also included in standby node 18 are a virtual machine monitor 22 and a cloning and seeding agent 24. The function of virtual machine monitor 18 is to monitor the operating status of each hot spare virtual machine 26. In particular, virtual machine monitor is able to monitoring the operating level of the virtual machine monitor and to compare that operating level to a set of predefined operating thresholds, including a maximum operating threshold. Cloning and seeding agent 24 performs at least two functions. Cloning and seeding agent 24 is operable to create a warm spare virtual machine 28 on the basis of an existing hot spare virtual machine 26. This process results in the cloning and seeding agent creating a clone of the hot spare virtual machine in the form of a warm spare virtual machine. As a seeding agent, cloning and seeding agents seeds the warm spare virtual machine with a license, thereby elevating the warm spare virtual machine to the status of a hot spare virtual machine and allowing the elevated virtual machine to handle all or some portion of the operating function of the associated primary node.

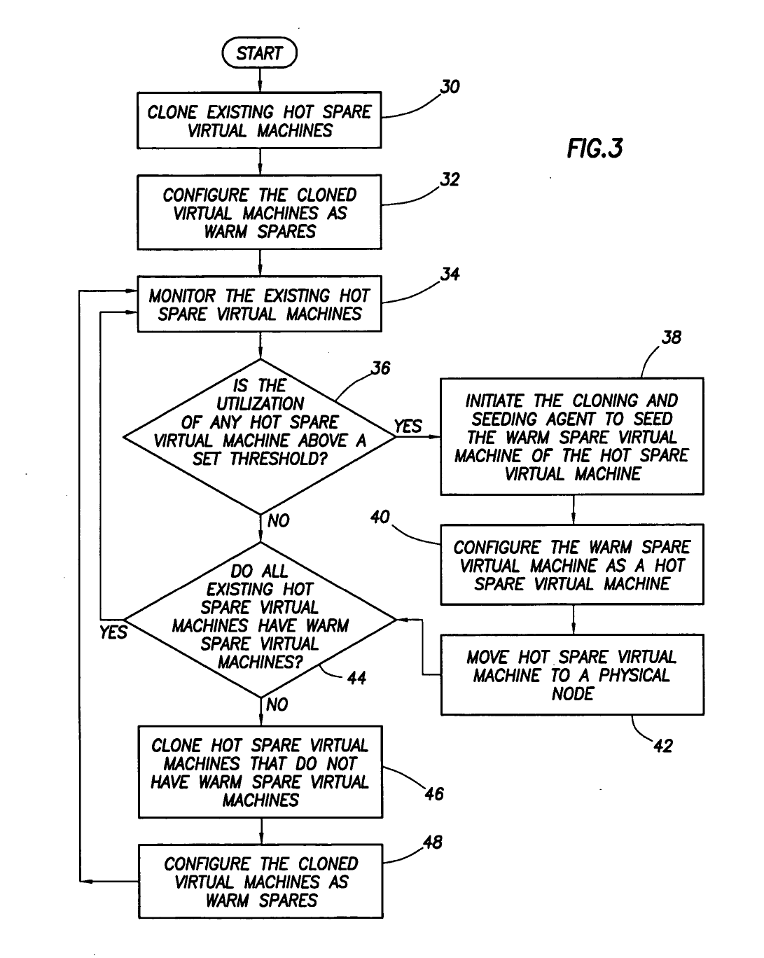

Shown in FIG. 3 is a flow diagram of a method for managing the operation and configuration of the hot spare virtual machines and warm spare virtual machines of the virtual nodes of a standby node. Following the start of the method steps a clone of each hot spare virtual machine is created at step 30. Step 30 involves the examination of each virtual node of the standby node to determine if a warm spare virtual machine exists for each hot spare virtual machine of the standby node. If a warm spare virtual machine does not exist for a hot spare virtual machine of a standby node, a clone of the hot spare virtual machine is created by cloning and seeding agent 24. At step 32, the clone of the hot spare virtual machine is configured as a warm spare virtual machine that is characterized as being unlicensed.

At step 34, virtual machine monitor 22 monitors the operating state of the hot spare virtual machines of the virtual nodes of the standby node. At step 36 an evaluation is made of whether the operating utilization of the hot spare virtual machine exceeds a predetermined threshold. This predetermined operating threshold could be met by the hot spare virtual machine because the entire operating system and all applications of the associated primary node have been restarted on the hot spare virtual machine or because some portion of the operating system or applications of the associated primary node have been restarted on the hot spare virtual machine. If it is determined that the operating utilization of the hot spare virtual machine exceeds an operating threshold, the cloning and seeding agent at step 38 seeds or establishes a license for the warm spare virtual machine. At step 40, the warm spare virtual machine is identified within the virtual node as an additional hot spare virtual machine. The overloaded hot spare virtual machine is migrated from the standby node to another physical node, where the virtual machine operates as another physical instance of the operating system or applications of the primary node. The migration of the overloaded hot spare virtual machine to a physical node frees space within the standby node so that another hot spare virtual machine that can be established as a backup for the newly established instance of the operating system or application in the primary node.

If it is determined at step 26 that the utilization of any hot spare of the standby node does not exceed a utilization threshold, it is next determined at step 44 if all hot spare virtual machines of the standby node are associated with a warm spare virtual machine. If it is determined at step 44 that all hot spare virtual machines are associated with a warm spare virtual machine, the flow diagram continues at step 34 with the continued monitoring the hot spare virtual machines of the standby node. If it is determined that all existing hot spare virtual machines do not have an associated warm spare virtual node, hot spare virtual machines that do not have associated warm spare virtual machines are cloned at step 46. The cloned versions of the hot spare virtual machines are configured at step 48 as unlicensed warm spare virtual machines. Following step 48, the flow diagram continues at step 34 with the continued monitoring of the hot spare virtual machines of each virtual node of the standby node. The method set out in FIG. 3 establishes a methodology in which each hot spare virtual machine is monitored to determine whether its utilization exceeds a threshold. When a hot spare virtual machine exceeds a threshold, the hot spare virtual machine is migrated to a primary node and a warm spare virtual machine is elevated to a hot spare virtual machine. In addition, a check is made to insure that each hot spare virtual machine is associated with a warm spare virtual machine. The method of FIG. 3 is a technique for monitoring the standby node to identify overutilized hot spare virtual machines and to insure a full complement of hot spare virtual machines and associated warm spare virtual machines within each virtual node of the standby node.

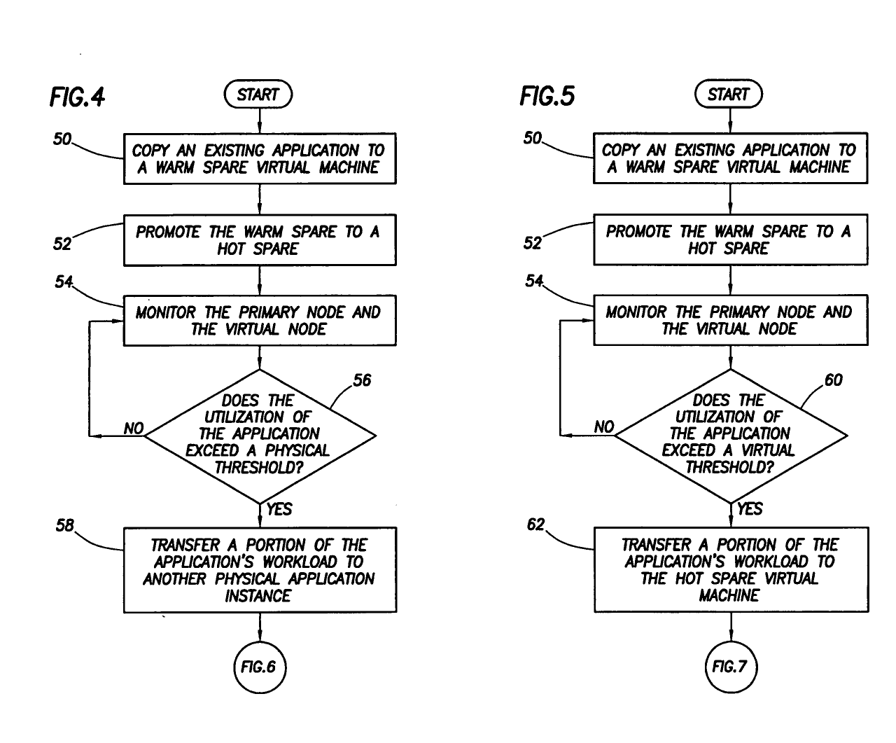

The server cluster architecture described herein may also be employed for the purpose of managing the utilization of the applications of the primary node and the standby node. Shown in FIG. 4 is a flow diagram of a series of method steps for managing the operation of a primary node on the basis of threshold utilization levels set with reference to the operation of the primary node. At steps 50, the application of the primary node is copied to a warm spare virtual machine in a virtual node of the standby node. As discussed, a warm spare virtual machine is an unlicensed replication of the hardware and software environment of the primary node. At step 52, the warm spare virtual machine is promoted to a licensed hot spare virtual machine. The step of promoting the licensed warm spare virtual machine to a hot spare virtual machine may be performed in response to the migration of the previously existing hot spare virtual machine to another physical node of the server cluster. At step 54, the utilization and other operating conditions of the primary node and the virtual node are monitored. At step 56, it is determined if the utilization of an application within the primary node exceeds a physical threshold set within the primary node. If it is determined that the utilization of the application within the primary node exceeds the predetermined threshold, a portion of the application's workload is transferred to another instance of the application. This second instance of the application may be on the same primary node or another primary node. The creation of the second instance of the application may necessitate the creation or modification of any virtual nodes corresponding to the affected primary node. If it is determined that the utilization of the application on the physical node does not exceed a predetermined threshold, the flow diagram continues with the continued monitoring of the primary node and virtual node at step 54. As indicated in the method of FIG. 4, the architecture set out herein may be employed for a methodology of evaluating whether the operation of an application of a primary node and migrating a portion of the application to a second application on another physical node of the server cluster.

Shown in FIG. 5 is a flow diagram of a series of method steps for managing the operation of a primary node on the basis of threshold utilization levels set with reference to the operation of the hot spare virtual machine. As was the case with the method of FIG. 4, steps 50, 52, and 54 involve, respectively, the copying of an existing application from the primary node to a warm spare virtual machine; the promotion of the warm spare virtual machine to a hot spare virtual machine; and the monitoring of the primary node and the virtual node. At step 60, it is determined if the utilization of an application of the primary node exceeds a predetermined threshold set with reference to the migration of some or all of the workload of the application to the hot spare virtual machine of the virtual node. If the utilization of the primary node exceeds this threshold, a portion of the workload of the application of the primary node is migrated to the hot spare virtual machine. As a result of the migration, the workload of the application is split between the primary node and the hot spare virtual machine, with one possible result being the more efficient handling of the application and a reduction in the likelihood of a failure of the application. If it is determined at step 60 that the utilization has not me the predetermined threshold for migration to the virtual machine, the flow diagram continues at step 54 with the continued monitoring of the applications of the virtual node and the primary node. As indicated, the architecture of primary nodes and corresponding virtual nodes that is set out herein permits the monitoring of the utilization of applications of the primary node and the migration of those applications to a virtual node in the event that the workload of the application exceeds a threshold level.

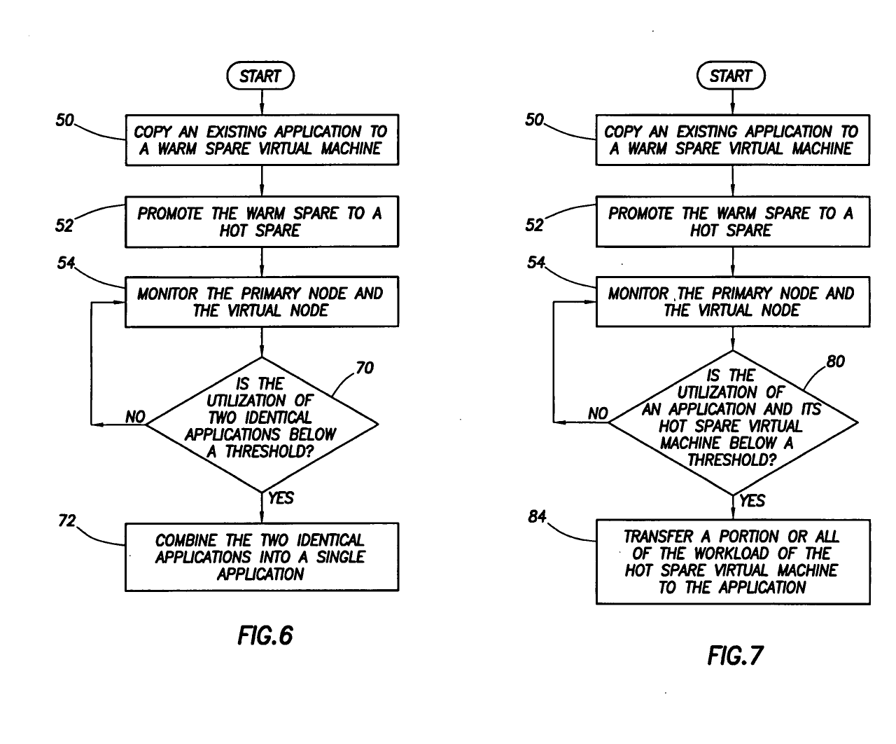

Shown in FIG. 6 is a flow diagram of a series of method steps for managing the operation of a primary node on the basis of redundancy threshold utilization levels set with reference to the operation of the application of the primary node. As was the case with the method of FIGS. 4 and 5, steps 50, 52, and 54 involve, respectively, the copying of an existing application from the primary node to a warm spare virtual machine; the promotion of the warm spare virtual machine to a hot spare virtual machine; and the monitoring of the primary node and the virtual node. At step 70, it is determined if the combined utilization of any two identical applications in the primary node falls below a threshold utilization level. If so, the two identical applications are combined into a single application at step 72. If the combined utilization of any two identical applications does not fall below a threshold utilization level, the monitoring of the applications of the primary node and virtual node continues at step 54. As such, applications within the primary node of the architecture described herein may be monitored to determine if two underutilized applications should be combined into a single application.

Shown in FIG. 7 is a flow diagram of a series of method steps for managing the operation of a primary node on the basis of redundancy threshold utilization levels set with reference to the operation of the hot spare virtual machine of the primary node. As was the case with the method of FIGS. 4-6, steps 50, 52, and 54 involve, respectively, the copying of an existing application from the primary node to a warm spare virtual machine; the promotion of the warm spare virtual machine to a hot spare virtual machine; and the monitoring of the primary node and the virtual node. At step 80, it is determined if the combined utilization of an application of a primary node and the corresponding hot spare virtual machine falls below a threshold utilization level. If so, the workload of the virtual machine is migrated to the application of the primary node at step 84. If the combined utilization of the application of the primary node and the application of the any two identical applications do not fall below a threshold utilization level, the monitoring of the applications of the primary node and virtual node continues at step 54. The architecture disclosed herein provides a methodology for migrating the workload of a hot spare virtual machine to an application of the primary node when the combined workload of the application of the primary node and the hot spare virtual machine reflects that the continued use of the hot spare virtual machine is unnecessary.

Shown in FIG. 8 is a flow diagram of a series of method steps for managing the operation of a warm spare virtual machine within a standby node. As was the case with the method of FIGS. 4-6, steps 50, 52, and 54 involve, respectively, the copying of an existing application from the primary node to a warm spare virtual machine; the promotion of the warm spare virtual machine to a hot spare virtual machine; and the monitoring of the primary node and the virtual node. At step 90, it is determined if the utilization of the hot spare virtual node is above a threshold utilization level. If so, the warm spare virtual machine is elevated to a hot spare virtual machine, thereby providing another licensed virtual machine to handle a portion of the workload of the existing hot spare virtual machine. If the utilization of the hot spare virtual node is not above a threshold utilization level, the monitoring of the applications of the primary node and the virtual node continues at step 54. Thus, the architecture disclosed herein provides a methodology for migrating the workload of a hot spare virtual machine to another hot spare virtual machine of the virtual node.

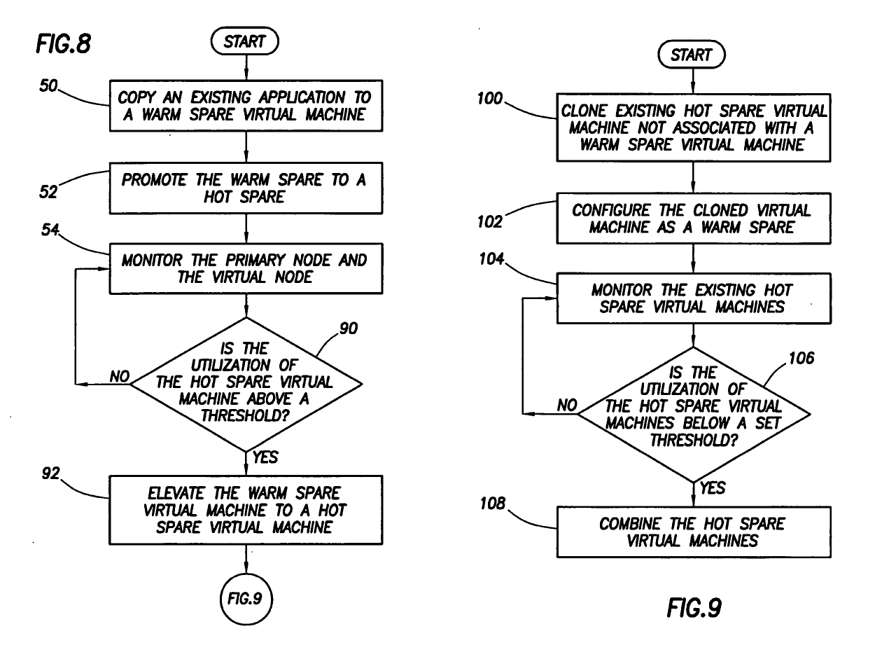

Shown in FIG. 9 is a series of method steps for monitoring the operation of virtual machines within a standby node. At step 100, copies are made of each hot spare virtual machine that is not associated with a warm spare virtual machine. As a result of the recent creation of one or more hot spare virtual machines, it is possible that one or more hot spare virtual machines may exist that are not associated with a warm spare virtual machine. Following step 100, each cloned hot spare virtual machine is configured as a warm spare virtual machine. At step 104, the utilization and other operating conditions of the hot spare virtual machines are monitored. If it is determined at step 106 that the combined utilization of two hot spare virtual machines is below a set threshold, the hot spare virtual machines are combined into a single hot spare virtual machine. If the combined utilization of two hot spare virtual machines not below a set threshold, the method continues at step 104 with the continued monitoring of the hot spare virtual machines of the standby node.

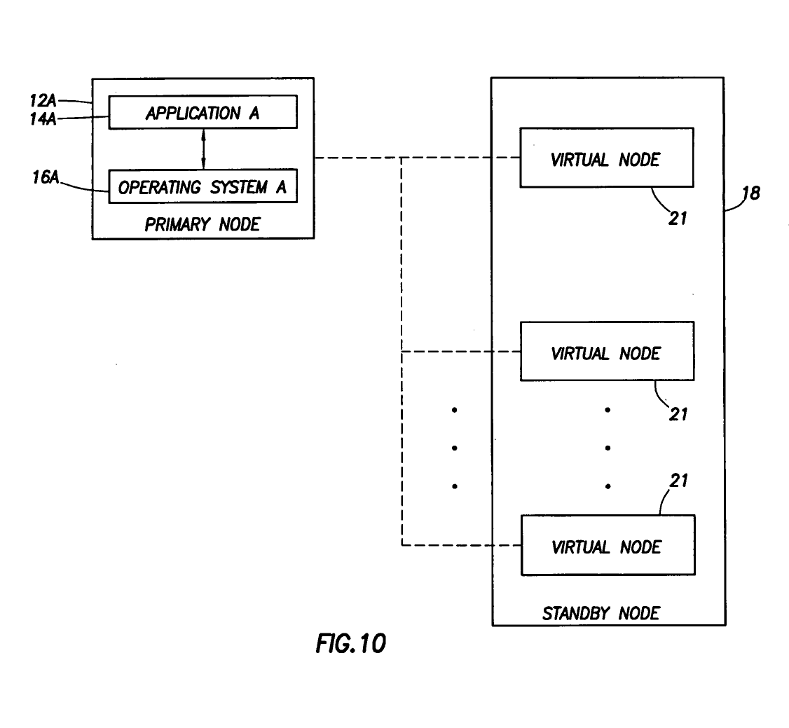

The server cluster architecture disclosed herein provides an architecture for the rapid scale-out of a physical application to multiple virtual applications. As shown by the diagram of FIG. 10, the operating system 16A and the software application 14A of the primary node 12A can be duplicated in one or more virtual nodes residing in one or more standby nodes. Thus, as the workload of the application residing on the physical node increases, the application of the physical node can be duplicated repeatedly in one or more virtual nodes. As one example, the combination of Application A and Operating System A may comprise a database server or a web server that may be accessed by multiple clients. As the demand on the software application of the primary node increases, one or more virtual versions 21 of the primary node can be initiated on standby node 18. Once these virtual versions of the standby node are initiated, the workload of the primary node can be distributed among the primary node and the instantiated virtual versions of the primary node in the standby node, thereby increasing the bandwidth or capacity of the application.

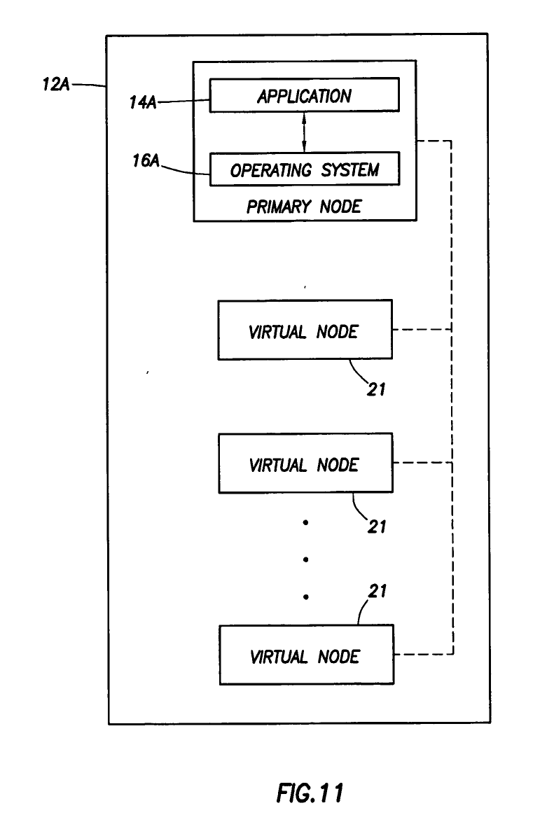

As an example, the application of the primary node could comprise a web server. If the demand on the web server of the primary node were to dramatically increase, one or more unique, virtual versions of the web server could be created in the standby node. As the demand on the physical and virtual versions of the web server application subsides, one or more of the virtual nodes could be terminated. The architecture of FIG. 10 provides for a physical application that resides on a first physical node and one or more virtual applications that reside on a second physical node. In this manner, the failure of one of the primary node or the standby node will not result in the failure of all of the instances of the application. It should be recognized, however, that the physical application and the one or more virtual versions of the application could reside on the same physical node. Shown in FIG. 11 is an example of a network architecture in which the physical application and the one or more virtual versions of the physical application reside on the same standby node. In the example of FIG. 11, application 14A and operating system 16A of the primary node reside on the same physical node as virtual nodes 21.

The architecture disclosed herein is also flexible, as it allows for virtual nodes to be initiated and terminated as needed and determined by the client demands on the network. As such, until a virtual node is needed, and therefore initiated, the virtual node need not be licensed. Similarly, once the need for the virtual node subsides, the virtual node can be terminated, thereby providing an opportunity to reduce the license cost being borne by the operator of the computer network.

The server cluster architecture and methodology disclosed herein provides for a server cluster in which the resources of the standby nodes are efficiently managed. In addition, the server cluster architecture described herein is efficient, as it provides a technique for managing the workload and the existence of the applications of each primary node and the virtual machines of each corresponding virtual node. Although the present disclosure has been described in detail, it should be understood that various changes, substitutions, and alterations can be made hereto without departing from the spirit and the scope of the invention as defined by the appended claims.

1. A server cluster, comprising:
a plurality of active nodes, wherein each active node is included within a physical node; and
a standby node associated with the plurality of active nodes, wherein the standby node comprises a physical node and includes a plurality of virtual nodes, wherein each virtual node is associated with an active node and wherein each virtual node comprises the hardware and software operating environment of the associated active node.

2. The server cluster of claim 1, wherein each virtual node comprises a virtual machine that is licensed and is configured to emulated the hardware and software operating environment of the associated active node.

3. The server cluster of claim 1, wherein each virtual node comprises:
a first virtual machine that is licensed and is configured to emulated the hardware and software operating environment of the associated active node; and
a second virtual machine that is unlicensed and is configured to emulated the hardware and software operating environment of the associated active node.

4. The server cluster of claim 1, wherein each virtual node comprises:
wherein each virtual node, comprises:
a first virtual machine that is licensed and is configured to emulated the hardware and software operating environment of the associated active node; and
a second virtual machine that is unlicensed and is configured to emulated the hardware and software operating environment of the associated active node; and
wherein the first virtual machine is operable to host the applications of a primary node in the event of a failure in the primary node.

5. The server cluster of claim 1, wherein each virtual node comprises:
wherein each virtual node, comprises:
a first virtual machine that is licensed and is configured to emulated the hardware and software operating environment of the associated active node; and
a second virtual machine that is unlicensed and is configured to emulated the hardware and software operating environment of the associated active node;
wherein the first virtual machine is operable to host the applications of an associated primary node in the event of a failure in the associated primary node; and
wherein the second virtual machine is operable to become a licensed virtual machine in the event that the first virtual machine hosts the applications of an associated primary node.

6. The server cluster of claim 1, wherein each virtual node comprises:
wherein each virtual node, comprises:
a first virtual machine that is licensed and is configured to emulated the hardware and software operating environment of the associated active node; and
a second virtual machine that is unlicensed and is configured to emulated the hardware and software operating environment of the associated active node;
wherein the first virtual machine is operable to host the applications of an associated primary node in the event of a failure in the associated primary node;
wherein the second virtual machine is operable to become a licensed virtual machine in the event that the first virtual machine hosts the applications of an associated primary node; and
wherein at least one of the plurality of active nodes runs a first operating system and wherein another of the plurality of active nodes

7. A method for configuring a standby node for a server cluster having a plurality of active nodes, comprising:
providing a physical standby node;
establishing, within the standby node and for each active node, a virtual node corresponding to the active node, wherein each virtual node comprises an emulated version of operating system of the physical standby node

8. The method for configuring a standby node for a server cluster of claim 7, wherein each virtual node comprises:
a hot spare virtual machine comprising an emulated representation of the operating system of the standby node; and
a warm spare virtual machine comprising an unlicensed, emulated representation of the operating system of the standby node.

9. The method for configuring a standby node for a server cluster of claim 8, further comprising:
monitoring the operation of the hot spare virtual machine to determine if the warm spare virtual machine should be migrated to the status of a hot spare virtual machine.

10. The method for configuring a standby node for a server cluster of claim 8, further comprising:
monitoring the operation of the hot spare virtual machine to determine if the warm spare virtual machine should be migrated to the status of a hot spare virtual machine; and
initiating the licensing of the warm spare virtual machine if it is determined that the warm spare virtual machine is to be migrated to the status of a hot spare virtual machine.

11. The method for configuring a standby node for a server cluster of claim 8, further comprising:
monitoring the operation of the hot spare virtual machine to determine if the warm spare virtual machine should be migrated to the status of a hot spare virtual machine;
imitating the licensing of the warm spare virtual machine if it is determined that the warm spare virtual machine is to be migrated to the status of a hot spare virtual machine; and
if the warm spare virtual machine is migrated to the status of a hot spare virtual machine, establishing a replacement warm spare virtual machine.

12. A method for managing the operational status of the application of a server cluster having a plurality of active nodes and a physical standby node, comprising the steps of:
establishing, within the standby node and for each active node, first and second standby virtual machines, wherein each virtual machine comprises an emulated representation of the operating environment of the corresponding active node;
monitoring the utilization of each of the first standby virtual machines;
migrating a first standby virtual machine to an active node if the operational status of the first standby virtual machine exceeds a threshold;
configuring the second standby virtual machine corresponding to the migrated first standby virtual machine as a replacement for the first standby virtual machine; and
creating a copy of the reconfigured second standby virtual machine as third standby virtual machine.

13. The method for managing the operational status of the application of a server cluster of claim 12, wherein the step of migrating a first standby virtual machine to an active node comprises the step of migrating the first standby virtual machine to an active node as a replacement for the failed active node corresponding to the first standby virtual machine.

14. The method for managing the operational status of the application of a server cluster of claim 12,
wherein the step of migrating a first standby virtual machine to an active node comprises the step of migrating the first standby virtual machine to an active node as a replacement for the failed active node corresponding to the first standby virtual machine; and
wherein the step of configuring the second standby virtual machine comprises the step of establishing a license for the second standby node and identifying the second standby node as a failover node for an active node.

15. The method for managing the operational status of the application of a server cluster of claim 12,
wherein the step of migrating a first standby virtual machine to an active node comprises the step of migrating the first standby virtual machine to an active node as a replacement for the failed active node corresponding to the first standby virtual machine;
wherein the step of configuring the second standby virtual machine comprises the step of establishing a license for the second standby node and identifying the second standby node as a failover node for an active node; and
wherein the third standby virtual machine comprises an unlicensed standby virtual machine.

16. A method for managing the operational status of the application of a server cluster having a plurality of active nodes and a physical standby node, comprising the steps of:
establishing, within the standby node and for each active node, a hot spare virtual machine and a warm spare virtual machine, wherein each of the hot spare virtual machine and each warm spare virtual machine is operable to act as a failover node for the corresponding active node;
monitoring the operational status of the applications of the active node; and
if the workload of an application of an active node exceeds a utilization threshold, migrating a portion of the workload of the application to the hot spare virtual machine corresponding to the active node.

17. The method for managing the operational status of the application of a server cluster of claim 16, further comprising the steps of:
monitoring the operational status of each hot spare virtual machine of the standby node; and
if, for any hot spare virtual machine that is executing a portion of the workload of an application of a corresponding active node, migrating the workload of the hot spare virtual machine to the active node if the combined utilization of the hot spare virtual machine and the application of the corresponding active node is below a utilization threshold.

18. The method for managing the operational status of the application of a server cluster of claim 16, further comprising the step of, for any hot spare virtual machine that includes a portion of the workload of an application of a corresponding active node, elevating the warm spare virtual machine corresponding to the status of a hot spare virtual machine to the status of a hot spare virtual machine.

19. A method for managing the operational status of the application of a server cluster having a plurality of active nodes and a physical standby node, comprising the steps of:
establishing, within the standby node and for each active node, a hot spare virtual machine and a warm spare virtual machine, wherein each of the hot spare virtual machine and each warm spare virtual machine is operable to act as a failover node for the corresponding active node;
monitoring the operational status of the applications of the active node;
if the workload of an application of an active node exceeds a utilization threshold, migrating a portion of the workload of the application to another active node of the server cluster; and
configuring within the standby node a hot spare virtual machine and a warm spare virtual machine for the migrated portion of the workload of the application.

20. A method for managing the operational status of the application of a server cluster having a plurality of active nodes and a physical standby node, comprising the steps of:
establishing, within the standby node and for each active node, a hot spare virtual machine and a warm spare virtual machine, wherein each of the hot spare virtual machine and each warm spare virtual machine is operable to act as a failover node for the corresponding active node;
monitoring the operational status of the applications of the active node;
if the workload of two identical applications of an active node exceeds a utilization threshold, combining the two identical applications to a single application; and
configuring within the standby node the corresponding hot spare virtual machine and a warm spare virtual machine to reflect the combined applications of the corresponding active node.

21. A method for managing the workload of an application of network, comprising the steps of:
monitoring the workload of the application;
initiating a virtual version of the application if the workload of the application exceeds a threshold; and
distributing the workload of the application between the application and the virtual version of the application.

22. The method for managing the workload of an application of network of claim 21, further comprising the step of creating additional virtual versions of the application if the combined workload of the application and the virtual version of the application exceeds a threshold.

23. The method for managing the workload of an application of network of claim 21, wherein the application and the virtual version of the application reside one separate server nodes.

24. The method for managing the workload of an application of network of claim 21, wherein the application and the virtual version of the application reside on the same server node.
